(19) United States
(12) Patent Application Publication
(10) Pub. No.: US 2016/0195768 A1
(43) Pub. Date: Jul. 7, 2016

(54) LIQUID CRYSTAL DISPLAY

(71) Applicant: Samsung Display Co., Ltd., Yongin-City (KR)

(72) Inventors: Wan-Soon IM, Cheonan-si (KR); Hyoung Cheol LEE, Suwon-si (KR); Nak Cho CHOI, Hwaseong-si (KR); Yong Woo HYUNG, Suwon-si (KR)

(21) Appl. No.: 14/809,535

(22) Filed: Jul. 27, 2015

(30) Foreign Application Priority Data
Jan. 7, 2015 (KR) 10-2015-0002078

(51) Int. Cl. G02F 1/1335

(52) U.S. Cl. CPC G02F 1/133553; G02F 1/133504; G02F 1/133528

(57) ABSTRACT

A liquid crystal display (LCD) includes: a liquid crystal panel; a backlight unit for supplying light to the liquid crystal panel; and a wavelength-converting reflector disposed between the liquid crystal panel and the backlight unit. Light reflected from the wavelength-converting reflector has a shorter wavelength as a reflection angle increases.

### CLAIM PRIORITY

This application claims priority to and the benefit of Korean Patent Application No. 10-2015-0002078 filed in the Korean Intellectual Property Office on Jan. 7, 2015, the entire contents of which are incorporated herein by reference.

### BACKGROUND

1. Field of Disclosure

This disclosure relates to a liquid crystal display (LCD).

2. Description of the Related Art

Liquid crystal displays (LCDs) are currently the most widely used flat panel displays.

An LCD consists of two substrates formed with electrodes and a liquid crystal layer interposed therebetween, and controls an amount of transmitted light by applying signals to the electrodes to realign liquid crystal molecules of the liquid crystal layer.

The above information disclosed in this Related Art section is only for enhancement of understanding of the background of the invention and therefore it may contain information that does not form the prior art that is already known in this country to a person of ordinary skill in the art.

### SUMMARY

However, a liquid crystal display (LCD) has a problem in that it has different visibilities at the front and at the sides, so various methods have been researched and developed to improve the problem.

As one of causes that deteriorate side visibility of the LCD, there is a yellowish phenomenon at the sides.

An exemplary embodiment of the present invention has been made in an effort to reduce the yellowish phenomenon at the sides of the LCD.

An LCD according to an exemplary embodiment of the present invention includes: a liquid crystal panel; a backlight unit for supplying light to the liquid crystal panel; and a wavelength-converting reflector disposed between the liquid crystal panel and the backlight unit. Light reflected from the wavelength-converting reflector has a shorter wavelength as a reflection angle increases.

The wavelength-converting reflector may include a cholesteric liquid crystal layer.

The cholesteric liquid crystal layer may include a transmissive portion and a reflective portion.

The reflective portion may have a stripe pattern.

The reflective portion may have a checkered pattern.

The reflective portion may be in a planar state, and the transmissive portion may be in a focal conic state.

The reflective portion may be in a perfect planar state.

A polarization film disposed between the liquid crystal panel and the wavelength-converting reflector may be further included.

A diffusion film and a prism film disposed between the wavelength-converting reflector and the backlight unit may be further included.

A wavelength-converting reflector according to an exemplary embodiment of the present invention includes: a transparent support film; and a cholesteric liquid crystal layer disposed on the support film. The cholesteric liquid crystal layer includes a transmissive portion and a reflective portion, and light reflected from the reflective portion has a shorter wavelength as a reflection angle increases.

The reflective portion may be in a planar state, and the transmissive portion may be in a focal conic state.

The reflective portion may be in a perfect planar state.

As described above, in the LCD according to the exemplary embodiment of the present invention, the wavelength-converting reflector using cholesteric liquid crystals increases blue light directed toward the sides by making the wavelength of light emitted to the sides shorter, thereby improving the yellowish phenomenon at the sides.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view of a liquid crystal display (LCD) according to an exemplary embodiment of the present invention.

FIG. 2 is a cross-sectional view of a wavelength-converting reflector according to the exemplary embodiment of the present invention.

FIG. 3 is a schematic view for illustrating a degree of wavelength conversion according to a reflection angle of the wavelength-converting reflector according to the exemplary embodiment of the present invention.

FIG. 4 is a cross-sectional view illustrating how cholesteric liquid crystals reflect light when they are in a perfect planar state.

FIG. 5 is a cross-sectional view illustrating how the cholesteric liquid crystals reflect light when they are not in the perfect planar state.

FIGS. 6 and 7 are layout views of wavelength-converting reflectors according to exemplary embodiments of the present invention.

### DETAILED DESCRIPTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A liquid crystal display (LCD) and a wavelength-converting reflector according to an exemplary embodiment of the present invention will now be described with reference to the drawings.

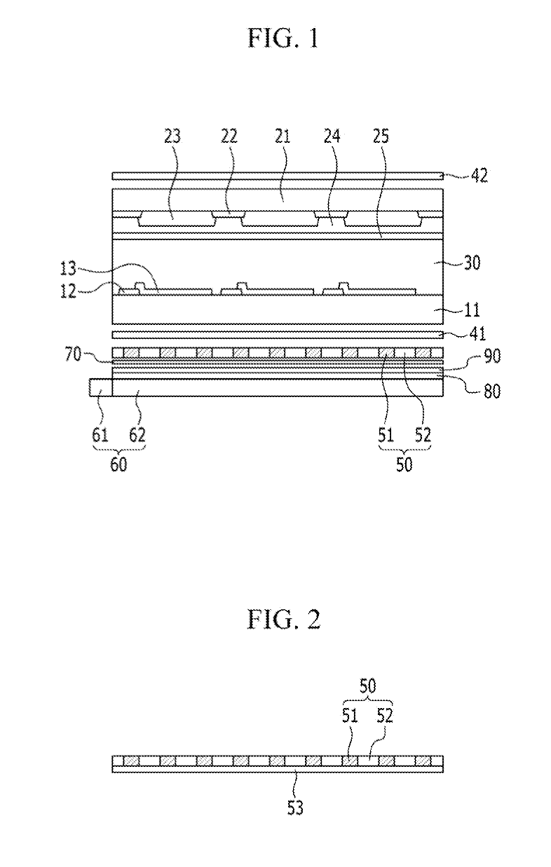

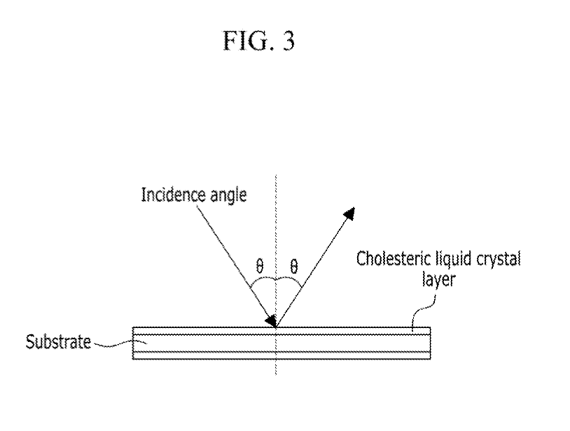

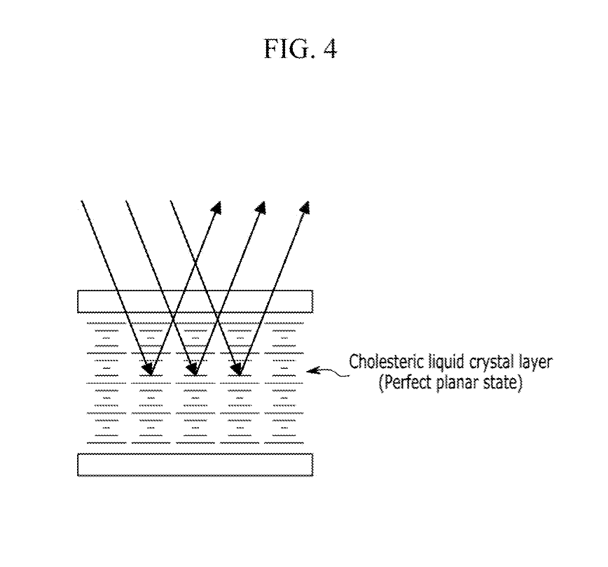

FIG. 1 is a cross-sectional view of a liquid crystal display (LCD) according to an exemplary embodiment of the present invention, FIG. 2 is a cross-sectional view of a wavelength-converting reflector according to the exemplary embodiment of the present invention, and FIG. 3 is a schematic view for illustrating a degree of wavelength conversion according to a reflection angle of the wavelength-converting reflector according to the exemplary embodiment of the present invention.

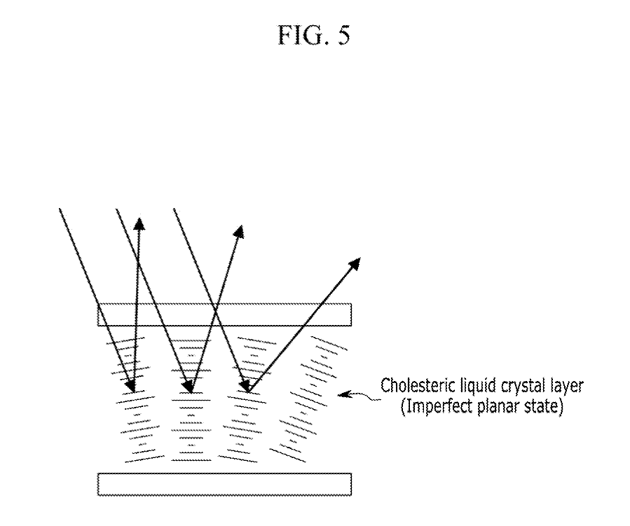

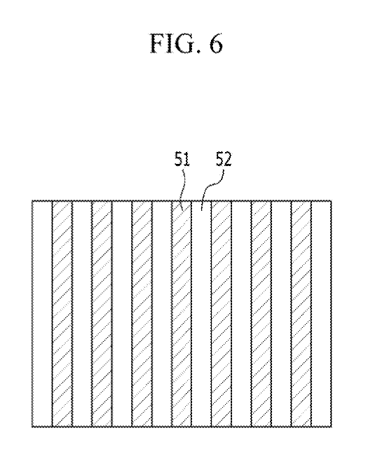

FIG. 4 is a cross-sectional view illustrating how cholesteric liquid crystals reflect light when they are in a perfect planar state, and FIG. 5 is a cross-sectional view illustrating how the cholesteric liquid crystals reflect light when they are not in the perfect planar state.

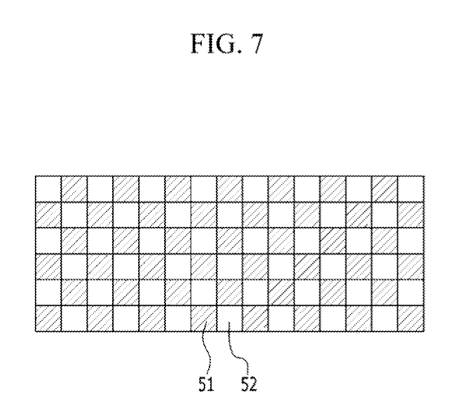

FIGS. 6 and 7 are layout views of wavelength-converting reflectors according to exemplary embodiments of the present invention.

Referring to FIG. 1, an emission type of display device according to an exemplary embodiment of the present invention includes a backlight unit 60 and a liquid crystal panel.

The backlight unit includes a light source 61 for emitting white light and a light guide for converting the white light emitted by the light source 61 into planar light to supply it to the liquid crystal panel.

The liquid crystal panel includes: a transparent lower substrate 11; a pixel electrode 13 formed on the lower substrate 11; a thin film transistor 12 formed on the lower substrate 11 to switch a voltage applied to the pixel electrode 13; a transparent upper substrate 21; color filters formed on a lower surface of the upper substrate 21; a light blocking member 22 disposed between the color filters 23; a planarization layer 24 disposed below the color filter 23 and the light blocking member 22 to cover the color filter 23 and the light blocking member 22; a common electrode 25 disposed below the planarization layer 24; and a liquid crystal layer 30 filled in a space between the pixel electrode 13 and the common electrode 25.

In this case, the color filters 23 includes red, green, and blue color filters, and in some cases, may include a white color filter that is formed of a transparent material and a scattering material.

A structure of the liquid crystal panel and the backlight unit are just exemplarily illustrated, and the backlight unit and the liquid crystal panel of various structures may be used.

For example, the backlight unit may be a direct type of backlight unit in which the light guide is not included, and the liquid crystal panel may have in-plane switching (IPS) mode in which the common electrode and the pixel electrode are both disposed on the same substrate.

A retarder 70, a wavelength-converting reflector 50, a first polarizer 41, etc. may be disposed between the liquid crystal panel and the backlight unit 60. The retarder 70 may be omitted.

A diffusion film 90 and a prism film 80 may be disposed between the back light unit 60 and the retarder 70. One or both of the diffusion film 90 and the prism film 80 may be omitted.

A second polarizer 42 is disposed on the upper substrate 21 of the liquid crystal panel.

A transmissive axis of the second polarizer 42 may be perpendicular to a transmissive axis of the first polarizer.

The wavelength-converting reflector 50 includes a reflective portion 51 and a transmissive portion 52.

The reflective portion 51 reflects light, and in this case, changes a wavelength of reflected light such that it is shorter than that of incident light.

Referring to FIG. 2, the wavelength-converting reflector 50 includes a transparent support film 53 and a cholesteric liquid crystal layer formed on the transparent support film 53.

The cholesteric liquid crystal layer configures the reflective portion 51 and the transmissive portion 52 depending on what state it is in.

The cholesteric liquid crystals of the reflective portion 51 are in a planar state, and those of the transmissive portion 52 are in a focal conic state.

The reflective portion 51 may be in the planar state, specifically, in a perfect planar state.

The wavelength-converting reflector 50 can be manufactured by applying the cholesteric liquid crystals on the support film 53 and then selectively heating or irradiating ultraviolet rays thereon to change arrangement of the liquid crystals of the reflective portion 51 and the transmissive portion 52.

Referring to FIG. 3, in the cholesteric liquid crystal layer in the planar state, light is reflected such that an incidence angle (θ) is identical to a reflection angle (θ), and the wavelength of reflected light (λ) is determined by the following equation.

λ=n×P×cos θ (Equation 1)

In the Equation 1, n is a refractive index of the cholesteric liquid crystals, and P is a pitch of the cholesteric liquid crystals.

According to Equation 1, the wavelength of the reflected light (A) decreases as the reflection angle increases.

Accordingly, the wavelength of light reflected from the wavelength-converting reflector 50 and directed toward the sides of the liquid crystal panel is shorter than that of light directed toward the front of the liquid crystal panel, and the shorter wavelength of light is reflected as the reflection angle increases from the normal of the liquid crystal panel.

Accordingly, at the sides of the liquid crystal panel, blue light of the shorter wavelength increases to compensate the yellowish phenomenon.

Referring to FIGS. 4 and 5, when the cholesteric liquid crystals are in the perfect planar state, incident light having the same incidence angle has the same reflection angle.

However, when the cholesteric liquid crystals are not in the perfect planar state, the reflection angle may be different for the same incidence angle.

Thus, for reflecting the shorter wavelength of light as a reflection angle increases, the perfect planar state may be better.

The reflective portion 51 and the transmissive portion 52 of the wavelength-converting reflector may be arranged in a stripe pattern, as shown in FIG. 6, or may be arranged in a checkered pattern, as shown in FIG. 7.

In addition to the patterns described above, the reflective portion 51 and the transmissive portion 52 may be arranged in various other patterns.

In the LCD of FIG. 1, the light provided by the backlight unit 60 enters the first polarizer 41 through the transmissive portion 52 of the wavelength-converting reflector 50, and is linearly polarized to progress toward the liquid crystal panel.

The liquid crystal panel changes polarization of the light using the arrangement of the liquid crystals that is changed depending on a voltage between the pixel electrode 13 and the common electrode 25.

The light having its polarization changed is detected by the second polarizer 42 to display the image.

Of the light transmitted through the transmissive portion 52 of the wavelength-converting reflector 50, there are light components that are reflected by the first polarizer 41 or the lower substrate 11 back to the wavelength-converting reflector 50.

Some of these light components are reflected by the reflective portion 51 of the wavelength-converting reflector 50 back to the liquid crystal panel such that they are reused.

In this case, the light reflected back to the liquid crystal panel by the wavelength-converting reflector 50 has shorter wavelengths as the reflection angle increases.

Accordingly, among the light progressing toward the sides of the liquid crystal panel, the blue light component increases to reduce the yellowish phenomenon at the sides.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal panel;
a backlight unit for supplying light to the liquid crystal panel; and
a wavelength-converting reflector disposed between the liquid crystal panel and the backlight unit, wherein light reflected from the wavelength-converting reflector has a shorter wavelength as a reflection angle increases.

2. The LCD of claim 1, wherein the wavelength-converting reflector is a film including a cholesteric liquid crystal layer.

3. The LCD of claim 2, wherein the cholesteric liquid crystal layer includes a transmissive portion and a reflective portion.

4. The LCD of claim 3, wherein the reflective portion has a stripe pattern.

5. The LCD of claim 3, wherein the reflective portion has a checkered pattern.

6. The LCD of claim 3, wherein the reflective portion is in a planar state, and the transmissive portion is in a focal conic state.

7. The LCD of claim 6, wherein the reflective portion is in a perfect planar state.

8. The LCD of claim 1, further comprising a polarization film disposed between the liquid crystal panel and the wavelength-converting reflector.

9. The LCD of claim 8, further comprising:
a diffusion film; and
a prism film disposed between the wavelength-converting reflector and the backlight unit.

10. A wavelength-converting reflector comprising:
a transparent support film; and
a cholesteric liquid crystal layer disposed on the transparent support film, wherein the cholesteric liquid crystal layer includes a transmissive portion and a reflective portion, and light reflected from the reflective portion has a shorter wavelength as a reflection angle increases.

11. An LCD including a wavelength-converting reflector of claim 10, wherein the reflective portion is in a planar state, and the transmissive portion is in a focal conic state.

12. The LCD of claim 11, wherein the reflective portion is in a perfect planar state.
